(19) United States
(12) Patent Application Publication
(10) Pub. No.: US 2003/0046155 A1
(43) Pub. Date: Mar. 6, 2003

(54) Incentive call minutes

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/942,753

(22) Filed: Aug. 30, 2001

(51) Int. Cl. G06F 17/60

(52) U.S. Cl. 705/14; 705/26

(57) ABSTRACT

A method, computer program, and data processing system for providing telephone call minutes as an incentive for participating in commercial transactions is disclosed. An amount of telephone minutes commensurate with a transaction (e.g., a number of minutes per dollar spent at a store) is crediting to a user's pre-paid telephone account in response to entering into a commercial transaction with an organization offering the incentive.

### BACKGROUND OF THE INVENTION

1. Technical Field

The present invention relates generally to business incentive programs. More specifically, the present invention is directed toward an incentive program that rewards customers by awarding telephone call minutes as an incentive for their continued business.

2. Description of Related Art

The mobile telephone has ushered in a new era in interpersonal communications. While the late 1990s' widespread consumer interest in the Internet made ours a wired world, technical advances and increased consumer appeal are ushering in a new “wireless world.” A number of mobile telephone manufacturers and service providers cater to a growing base of mobile telephone subscribers.

Unlike most local telephone service in the United States, but akin to long-distance service, mobile telephone service is usually billed in minutes of airtime. That is, the amount a customer is charged is proportional to the amount of time spent in mobile telephone calls. For instance, a five minute call will usually cost five times as much as a one minute call.

Because having every minute of every call charged for is a major discouragement to consumers wishing to use mobile telephones, mobile service providers often employ a billing system in which customers pre-pay for a certain number of minutes of airtime each month. When a customer makes a call, the minutes of airtime are subtracted from the customer's balance of minutes for the month. Any additional minutes exceeding the customer's pre-paid balance are billed for separately. In most billing schemes, the current month's minutes expire at the end of the month if not used.

Thus, many mobile telephone customers pay for their telephone usage by redeeming pre-paid credits (measured in minutes of airtime). This scheme has many analogs in other areas of business. For instance, most individuals will mail a letter by first buying a pre-paid postage credit (i.e., a postage stamp), then redeeming the credit (i.e., mailing the letter with the stamp attached). This pre-paid telephone service has now also become available for service on non-mobile telephones.

As pre-paid telephone minutes for mobile telephone service and long-distance service have become popular, it would be desirable to capitalize on the popularity of these services to provide incentives to business customers. This is especially true when one considers the increasing number of functions for which mobile phones are being used. For example, in addition to normal voice conservation, mobile phones are already being used for Internet access.

### SUMMARY OF THE INVENTION

The present invention provides a method, computer program, and data processing system for providing telephone call minutes as an incentive for participating in commercial transactions. An amount of telephone minutes commensurate with a transaction (e.g., a number of minutes per dollar spent at a store) is crediting to a user's pre-paid telephone account in response to entering into a commercial transaction with an organization offering the incentive.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 is a diagram depicting an overall view of system for providing incentive telephone call minutes in a preferred embodiment of the present invention;

FIG. 5 depicts a diagram illustrating the format of an account database in accordance with the present invention; and

FIG. 6 depicts a flowchart representation of a process of awarding incentive call minutes in accordance with a preferred embodiment of the present invention.

### DETAILED DESCRIPTION OF THE PREFERRED EMBODIMENT

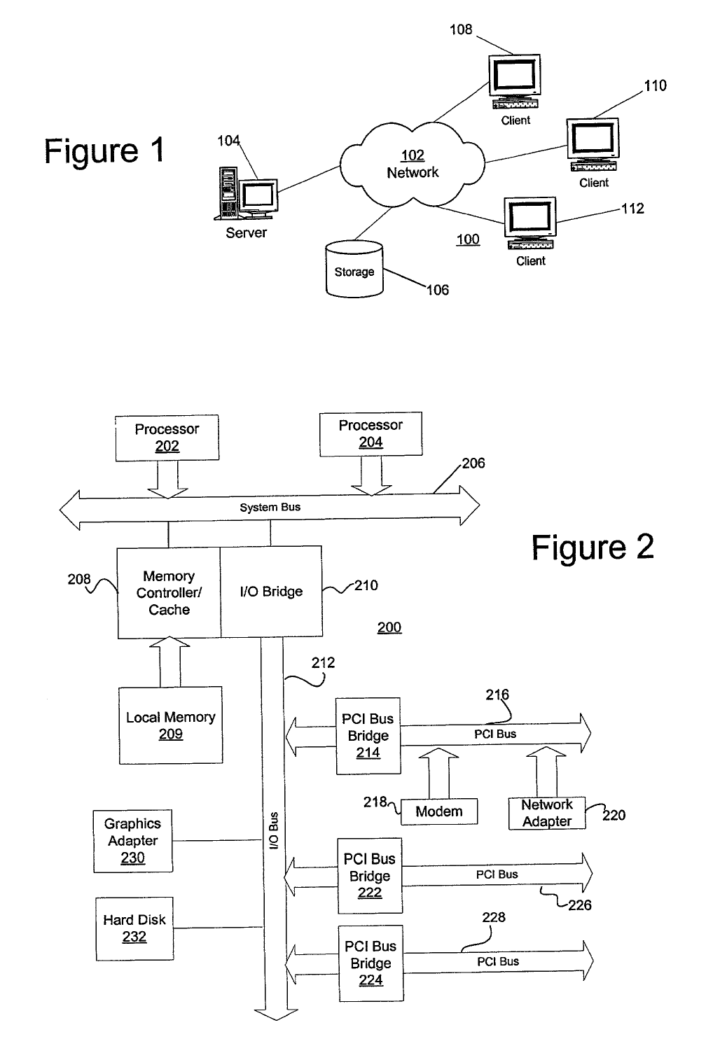

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216, Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

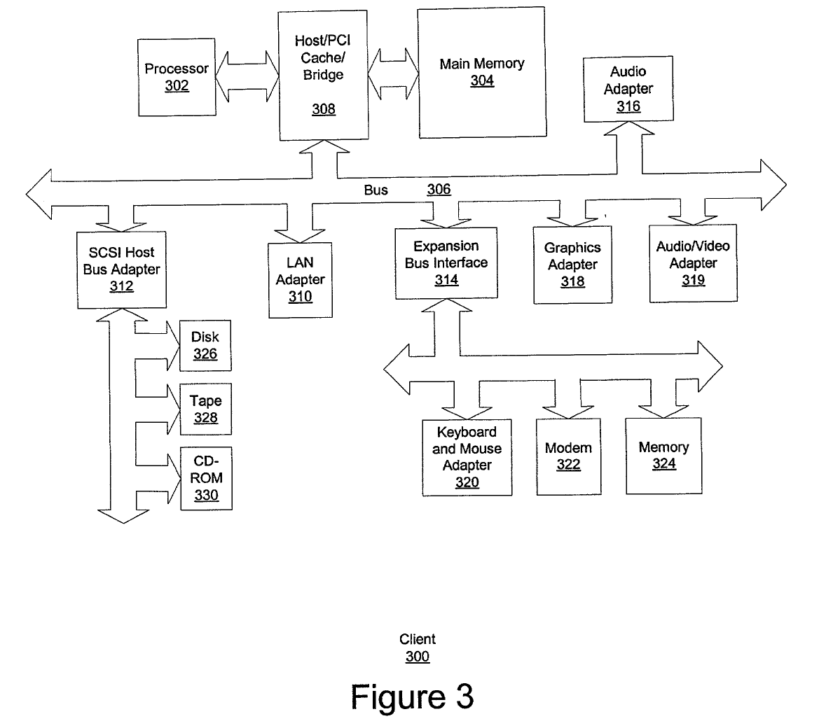

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

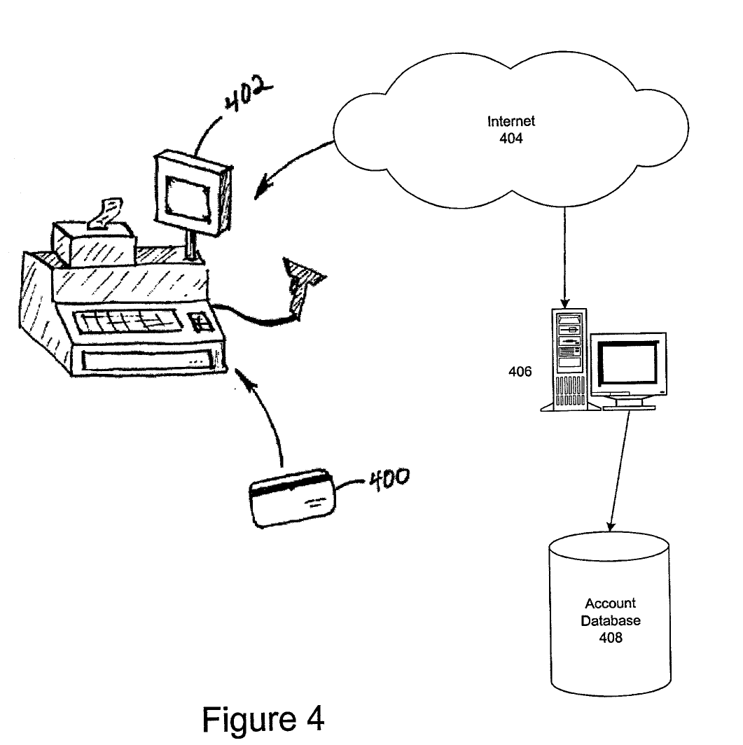

FIG. 4 is a diagram depicting an overall view of system for providing incentive telephone call minutes in a preferred embodiment of the present invention. Identification card 400 stores an account number identifying a user's pre-paid telephone service account. A user presents identification card 400 to be read by point-of-sale terminal 402, which is a type of client computer. Note that the embodiment depicted in FIG. 4 is intended to be operated in the context of a retail shopping establishment; one of ordinary skill in the art will recognize that the invention is not limited to application in retail, but may be used in conjunction with any type of commercial transaction and any appropriate type of data processing or computer equipment for carrying out such transactions, such as an airline reservation system, for example.

Also, it should be noted that identification card 400 is merely representative of a number of identification devices that may be employed within the present invention. Alternatively, a human operator could manually enter information into point-of-sale terminal 402 identifying the user and his/her telephone service account number.

Point-of-sale terminal 402 registers a commercial transaction (in this case, a sale of goods or services) and calculates a number of incentive call minutes to be credited to the telephone account associated with identification card 400 as a business incentive. The number of minutes will be commensurate with the commercial transaction performed. For instance, a number of minutes that is proportional to the amount purchased by the user may be credited to the user's account. Other (possibly arbitrary) formulas or methods of calculating an appropriate number of minutes may be applied.

Point-of-sale terminal 402 transmits the number of call minutes and the user's telephone service account number through Internet 404 to server 406, which is associated with the user's telephone service provider. Server 406 credits the appropriate number of minutes to the user's account by updating account database 408.

Point-of-sale terminal 402 includes displays for displaying information about the status of a commercial transaction to both the operator of point-of-sale terminal 402 and to a customer. A keyboard allows an operator to manually enter alphanumeric and other information into point-of-sale terminal 402. A magnetic card reader may be used to read the contents of plastic identification cards, such as credit cards or identification card 400 into the memory of point-of-sale terminal 402. Point-of-sale terminal can be supplemented with a number of peripheral devices for reading information from identification cards or other identification devices.

Identification card 400 might several identification mechanisms in common use. For example, identification card 400 might include a magnetic stripe made of a magneto resistive material. An account number may be recorded on the magnetic stripe and read using a magnetic card reader. Alternatively, a barcode can also be used to encode an account number, which can then be read using a laser barcode reader. Information, such as an account number or other identifying information may also be stored in a small microprocessor and memory embedded within identification card 400. This information may be accessed by a reader making electrical contact with the card and interfacing with the embedded microprocessor. Identification and other cards that contain an embedded microprocessor and contact pad are known as smart cards.

Identification card 400 may also contain a radio-frequency identification (RFID) tag. This tag may be written to or read from by subjecting it to a radio-frequency signal. The integrated circuit in the RFID tag collects all of its power from the energy in the radio-frequency signal. RFID tags provide a ready form of identification or marking of an object.

In addition to the example of identification card 400, RFID technology can take many forms and be used in many contexts. One example is an RFID key fob, which is an RFID tag that is attached to a key ring.

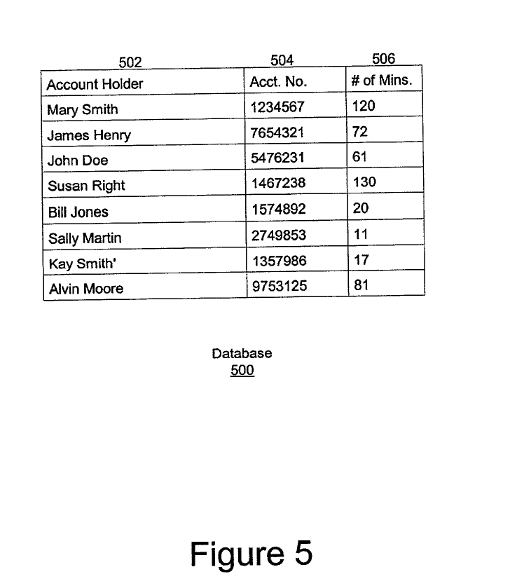

Referring now to FIG. 5, a diagram illustrating the format of an account database, such as account database 408 in FIG. 4, is depicted in accordance with the present invention. Database 500 may be implemented using any of a number of database infrastructures, including (but not limited to) relational and object-oriented database types. Database 500 includes entries for each of the customers of a telephone service provider. Account holder field 502 stores the name or identity of each customer. Account number field 504 stores an account number for each customer, which may the customer's telephone number. Number of minutes field 506 stores a customer's balance of available call minutes. Crediting a customer's account with incentive call minutes involves adding a number of minutes to the balance stored in number of minutes field 506 for that customer.

Note that the minutes amounts stored in database 500 may correspond to any type of pre-paid call minutes: long distance minutes, local call minutes, e-mail, calendar downloads, and any other type of mobile telephone airtime minutes.

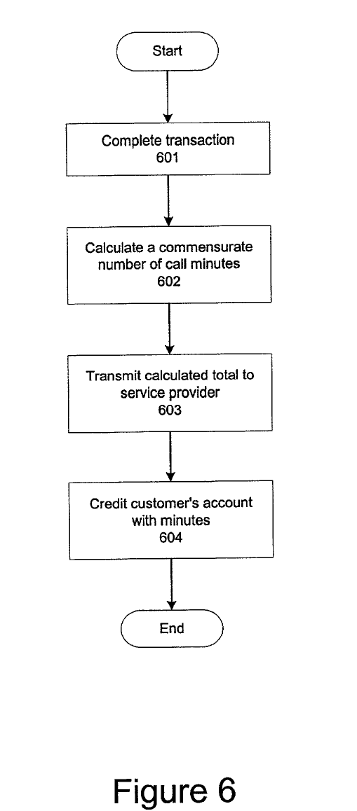

Referring to FIG. 6, a flowchart representation of a process of awarding incentive call minutes is depicted in accordance with a preferred embodiment of the present invention. First, a transaction with a customer is completed (step 601). An amount of call minutes to be credited to the customer's telephone account is calculated that is commensurate with the transaction performed (step 602). The total minutes are then sent to the mobile phone service provider (step 603). Finally, the customer's account is credited by the number of minutes calculated (step 604).

In addition to the “brick and mortar” commercial transactions described above, the present invention can also be applied to Internet transactions. This is especially important as mobile phones are applied to an increasing range of function, such as Internet access. In the future, mobile phones may also be applied to other functions, such as bank account access, activation of home appliances, arming/disarming home security systems, and transmission of medical data (e.g., pulse rate and blood pressure). The present invention may be applied to any of the above functions, as well as any other type of mobile phone “air time”. The invention is not limited to merely voice communication time.

The present invention also is not limited to purchases. Although purchases are likely to be the most common type of commercial transaction encountered, the present invention applies to any type of exchange of service, and is not restricted to a point-of-sale. The present invention may be applied to rental agreements. For example, the present invention may be applied to car rental, wherein the customer acquires call minutes in proportion to the number of miles driven.

Another example, is acquiring call minutes just for taking a test drive at a car dealership, wherein not actual sale has to take place. This could apply to any type of product/service test or sample.

Call minutes may also be awarded for the length of subscriptions. For example, the number of call minutes would increase with the length of a magazine subscription (e.g., 6 months, 1 year, 2 year). Subscriptions might also include cable TV and Internet service.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
in response to a commercial transaction, crediting an account of telephone call minutes with a number of additional call minutes commensurate with the commercial transaction.

2. The method of claim 1, wherein the account of telephone call minutes is an account of mobile telephone airtime minutes.

3. The method of claim 1, wherein the account of telephone call minutes is an account of pre-paid long-distance call minutes.

4. The method of claim 1, wherein the commercial transaction is a purchase.

5. The method of claim 4, wherein the number of additional call minutes is commensurate with the amount of the purchase.

6. The method of claim 4, wherein the purchase is made over the Internet.

7. The method of claim 1, wherein the commercial transaction is a rental agreement.

8. The method of claim 1, wherein the commercial transaction is a product test.

9. The method of claim 1, further comprising:
reading an identification code identifying the account of telephone call minutes from an identification device at a point-of-sale terminal; and
processing the commercial transaction at the point-of-sale terminal.

10. A computer program product in a computer-readable medium for use in a data processing system, the computer program product comprising:
in response to a commercial transaction instructions for crediting an account of telephone call minutes with a number of additional call minutes commensurate with the commercial transaction.

11. The computer program product of claim 10, wherein the account of telephone call minutes is an account of mobile telephone airtime minutes.

12. The computer program product of claim 10, wherein the account of telephone call minutes is an account of pre-paid long-distance call minutes.

13. The computer program product of claim 10, wherein the commercial transaction is a purchase.

14. The computer program product of claim 13, wherein the number of additional call minutes is commensurate with the amount of the purchase.

15. The computer program product of claim 13, wherein the purchase is made over the Internet.

16. The method of claim 10, wherein the commercial transaction is a rental agreement.

17. The method of claim 10, wherein the commercial transaction is a product test.

18. The computer program product of claim 10, further comprising:
instructions for reading an identification code identifying the account of telephone call minutes from an identification device at a point-of-sale terminal; and
instructions for processing the commercial transaction at the point-of-sale terminal.

19. A data processing system comprising:
a bus system;
a processing unit connected to the bus system and including at least one processor;
memory connected to the bus system;
a set of instructions in the memory, wherein the processing unit executes the set of instructions to perform the acts of:
in response to a commercial transaction, crediting an account of telephone call minutes with a number of additional call minutes commensurate with the commercial transaction.

20. The data processing system of claim 19, wherein the account of telephone call minutes is an account of mobile telephone airtime minutes.

21. The data processing system of claim 19, wherein the account of telephone call minutes is an account of pre-paid long-distance call minutes.

22. The data processing system of claim 19, wherein the commercial transaction is a purchase.

26. The data processing system of claim 22, wherein the number of additional call minutes is commensurate with the amount of the purchase.

27. The data processing system of claim 22, wherein the purchase is made over the Internet.

28. The data processing system of claim 19, wherein the commercial transaction is a rental agreement.

29. The data processing system of claim 19, wherein the commercial transaction is a product test.

30. The data processing system of claim 19, wherein the processing unit executes the set of instructions to perform the acts of:
reading an identification code identifying the account of telephone call minutes from an identification device at a point-of-sale terminal; and
processing the commercial transaction at the point-of-sale terminal.
